(19) United States
(12) Patent Application Publication
(10) Pub. No.: US 2024/0086360 A1
(43) Pub. Date: Mar. 14, 2024

(54) FILE SAVING METHOD AND ELECTRONIC DEVICE

(71) Applicant: GUANGDONG OPPO MOBILE TELECOMMUNICATIONS CORP., LTD., Dongguan (CN)

(72) Inventor: Piaoyu Sun, Dongguan (CN)

(21) Appl. No.: 18/512,882

(22) Filed: Nov. 17, 2023

Related U.S. Application Data
(63) Continuation of application No. PCT/CN2022/080708, filed on Mar. 14, 2022.

(30) Foreign Application Priority Data
May 20, 2021 (CN) 202110553052.1

(51) Int. Cl. G06F 16/11; G06F 16/16; H04L 67/06

(52) U.S. Cl. CPC G06F 16/113; G06F 16/16; H04L 67/06

(57) ABSTRACT

Provided are a file saving method, and an electronic device. In the method, while the first electronic device displays, through screen projection, a display interface of a second electronic device, in response to a file open operation, a first file is opened and displayed at the first electronic device, where the first file is a file to which a file path displayed in the display interface points. In response to a file editing operation, the first file is edited at the first electronic device, and the edited first file is obtained as a second file. The second file is sent to the second electronic device, so as to instruct the second electronic device to save the second file to a public directory and then migrate the second file to an original directory of the first file, thereby replacing the first file with the second file.

### CROSS-REFERENCING OF RELEVANT APPLICATIONS

This application is a continuation of International Patent Application No. PCT/CN2022/080708, filed on Mar. 14, 2022, which claims priority to Chinese patent application No. CN202110553052.1, filed on May 20, 2021, both of which are herein incorporated by reference in their entireties.

### TECHNICAL FIELD

The present disclosure relates to the technical field of electronic devices, and particularly to a file saving method and an electronic device.

### BACKGROUND

With the development of science and technology, smartphones are more and more widely used, and they have more and more functions. Smart phones have become one of the necessities in people's daily life. At present, the smartphones need to use software thereon when editing documents, graphics and texts, audios, videos, and the like.

### SUMMARY

In view of the above, the present disclosure proposes a file saving method and an electronic device.

In a first aspect, the embodiments of the present disclosure provide a file saving method for a first electronic device. In the method, while the first electronic device displays, through screen projection, a display interface of a second electronic device, in response to a file open operation, a first file is opened and displayed at the first electronic device, where the first file is a file to which a file path displayed in the display interface points. In response to a file editing operation, the first file is edited at the first electronic device, and the edited first file is obtained as a second file. The second file is sent to the second electronic device, so as to instruct the second electronic device to save the second file to a public directory and then migrate the second file to an original directory of the first file, thereby replacing the first file with the second file.

In a second aspect, the embodiments of the present disclosure provide a file saving method for a second electronic device. In the method, a second file sent from a first electronic device is received, where the second file is obtained by editing, in response to a file editing operation, a first file by the first electronic device, and the first file is opened and displayed, in response to a file open operation, at the first electronic device while the first electronic device displays, through screen projection, a display interface of the second electronic device, the first file being a file to which a file path displayed in the display interface points. The second file is saved to a public directory. The second file saved in the public directory is migrated to an original directory of the first file, thereby replacing the first file with the second file.

In a third aspect, the embodiments of the present disclosure provides an electronic device including a memory and a processor. The memory is coupled to the processor, and the memory stores instructions which, when being executed by the processor, cause the processor to: while the electronic device displays, through screen projection, a display interface of a further electronic device, in response to a file open operation, open and display a first file at the electronic device, wherein the first file is a file to which a file path displayed in the display interface points; in response to a file editing operation, edit the first file at the electronic device, and obtain the edited first file as a second file; and send the second file to the further electronic device, so as to instruct the further electronic device to save the second file to a public directory and then migrate the second file to an original directory of the first file, thereby replacing the first file with the second file.

Other features and aspects of the disclosed features will become apparent from the following detailed description, taken in conjunction with the accompanying drawings, which illustrate, by way of example, the features in accordance with embodiments of the disclosure. The summary is not intended to limit the scope of any embodiments described herein.

### BRIEF DESCRIPTION OF THE DRAWINGS

In order to provide clearer explanation of technical solutions in the embodiments of the present disclosure, drawings required in the description of the embodiments are introduced briefly below. It is evident that the drawings in the following description are only some embodiments of the present disclosure. For those skilled in the art, other drawings may be obtained based on these drawings without any creative effort.

FIG. 1 illustrates a schematic diagram of an application environment in which a file saving method provided in the embodiments of the present disclosure may be applied.

FIG. 2 illustrates a timing diagram of a file saving method provided in the embodiments of the present disclosure.

FIG. 3 illustrates a schematic diagram of a first interface of a first electronic device provided in the embodiments of the present disclosure.

FIG. 4 illustrates a schematic diagram of a second interface of the first electronic device provided in the embodiments of the present disclosure.

FIG. 5 illustrates a schematic diagram of a third interface of the first electronic device provided in the embodiments of the present disclosure.

FIG. 6 illustrates a schematic flowchart of a file saving method provided in an embodiment of the present disclosure.

FIG. 7 illustrates a schematic flowchart of a file saving method provided in another embodiment of the present disclosure.

FIG. 8 illustrates a schematic flowchart of a file saving method provided in a further embodiment of the present disclosure.

FIG. 9 illustrates a schematic flowchart of a file saving method provided in yet a further embodiment of the present disclosure.

FIG. 10 illustrates a schematic diagram of a fourth interface of the first electronic device provided in the embodiments of the present disclosure.

FIG. 11 illustrates a schematic flowchart of a file saving method provided in yet a still further embodiment of the present disclosure.

FIG. 12 illustrates a schematic diagram of a fifth interface of the first electronic device provided in the embodiments of the present disclosure.

FIG. 13 illustrates a schematic flowchart of a file saving method provided in yet a still further embodiment of the present disclosure.

FIG. 14 illustrates a schematic flowchart of a file saving method provided in yet a still further embodiment of the present disclosure.

FIG. 15 illustrates a schematic diagram of a fifth interface of the first electronic device provided in the embodiments of the present disclosure.

FIG. 16 illustrates a first schematic interaction diagram provided in the embodiments of the present disclosure.

FIG. 17 illustrates a schematic diagram of a sixth interface of the first electronic device provided in the embodiments of the present disclosure.

FIG. 18 illustrates a schematic flowchart of a file saving method provided in yet a still further embodiment of the present disclosure.

FIG. 19 illustrates a second schematic interaction diagram provided in the embodiments of the present disclosure.

FIG. 20 illustrates a schematic diagram of an interface of a second election device provided in the embodiments of the present disclosure.

FIG. 21 illustrates a schematic flowchart of a file saving method provided in yet a still further embodiment of the present disclosure.

FIG. 22 illustrates a schematic module block diagram of a file saving apparatus provided in an embodiment of the present disclosure.

FIG. 23 illustrates a schematic module block diagram of a file saving apparatus provided in another embodiment of the present disclosure.

FIG. 24 illustrates a schematic block diagram of an electronic device for implementing the file saving method provided in the embodiments of the present disclosure.

FIG. 25 illustrates a storage unit for saving or carrying program codes that implement the file saving method provided in the embodiments of the present disclosure.

### DETAILED DESCRIPTION OF EMBODIMENTS

In order to make those skilled in the art better understand the solutions of the present disclosure, the technical solutions in the embodiments of the present disclosure will be described clearly and comprehensively with reference to the drawings below.

At present, smartphones need to use software thereon when editing documents, graphics and texts, audios, videos, and the like. However, due to limitations of the performance and hardware of the smartphone itself, it is inconvenient to edit the documents, graphics and texts, audios, videos and the like, resulting in a poor user experience. If a file in the smartphone is desired to be opened and processed on a computer, the file in the smartphone needs to be transferred to the computer first. In a case where the smartphone and the computer are not connected with the Internet, it is necessary to first connect the smartphone and the computer through a data cable, copy the file in the smartphone to the computer, and then copy the edited file, which has been edited on the computer, back to the smartphone. In a case where the smartphone and the computer are connected with the Internet, the file in the smartphone may be uploaded to a relay platform, and then it is downloaded, from the relay platform, onto the computer for editing; thereafter, the computer uploads the edited file to the relay platform, and the smartphone downloads the edited file from the relay platform. Therefore, this approach is inconvenient due to cross-end transfer of the file between the smartphone and the computer, resulting in the poor user experience.

In view of the above problems, the inventors propose, through long-term research, a file saving method and apparatus, an electronic device and a storage medium provided in the embodiments of the present disclosure, in which a file edited at a first electronic device is sent to a second electronic device, and it is first saved in a public directory at the second electronic device and then migrated to an original directory of the first file. This avoids a problem of lacking read and write access to a file, and enables editing, at the first electronic device cross ends, of a file in any directory of the second electronic device, and saving of the edited file back to the second electronic device. As such, a success rate of saving the file cross ends is improved. The specific file saving method is described in detail in subsequent embodiments.

An application environment in which the file saving method provided in the embodiments of the present disclosure may be applied is described in the following.

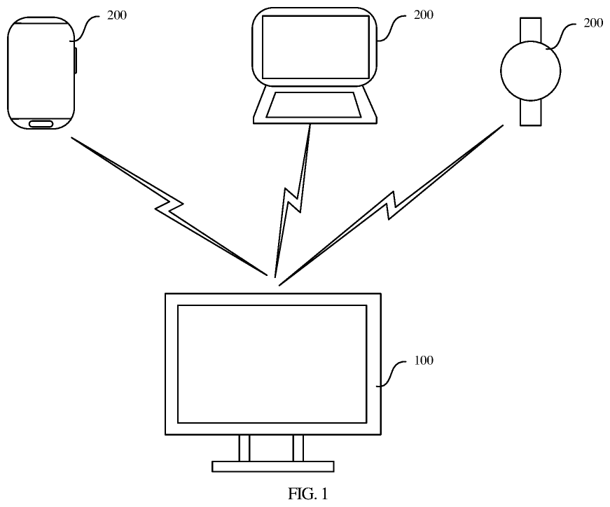

Referring to FIG. 1, a schematic diagram of an application environment in which the file saving method provided in the embodiments of the present disclosure may be applied is illustrated in FIG. 1. As illustrated in FIG. 1, the application scenario may include a first electronic device 100 and a second electronic device 200. The first electronic device 100 may be a computer as illustrated in FIG. 1. Of course, the first electronic device 100 may also be other devices with a display function, such as a smart TV, and a tablet computer, which is not limited here. The second electronic device 200 may be a smartphone, the tablet computer, a smart watch and other devices. In the application scenario, the second electronic device 200 may serve as a device providing a display interface, and the display interface is displayed, through screen projection, at the first electronic device 100. Of course, the second electronic device 200 may further transmit an audio content to the first electronic device 100 for playing, or transmit a file to the first electronic device 100 for opening and so on, which is not limited here.

In some embodiments, the first electronic device 100 and the second electronic device 200 may communicate with each other for data interaction. For example, the first electronic device 100 and the second electronic device 200 may establish an end-to-end network connection (i.e., P2P network connection) through Bluetooth, Zigbee, WebRTC, WiFi direct connection or other communication modes, and communicate with each other through the established network connection. Alternatively, the first electronic device 100 and the second electronic device 200 may establish a connection through a wireless screen projection protocol, and transmit data therebetween through WLAN. Of course, the communication mode between the first electronic device 100 and the second electronic device 200 may not be limited.

In some scenarios, the first electronic device 100 may be a large-screen device (such as the smart computer illustrated in FIG. 1), and the user may perform screen projection to project a display interface of a small-screen device, such as a smartphone, a tablet computer and a smart watch, onto the large-screen device for display, thus improving the user's experience when viewing the display interface. In addition, the first electronic device 100 may further operate the display interface projected from the second electronic device 200, so as to process the display interface projected from the second electronic device 200. For example, the first electronic device 100 may further open a file in the display interface projected from the second electronic device 200, so as to edit and save the opened file.

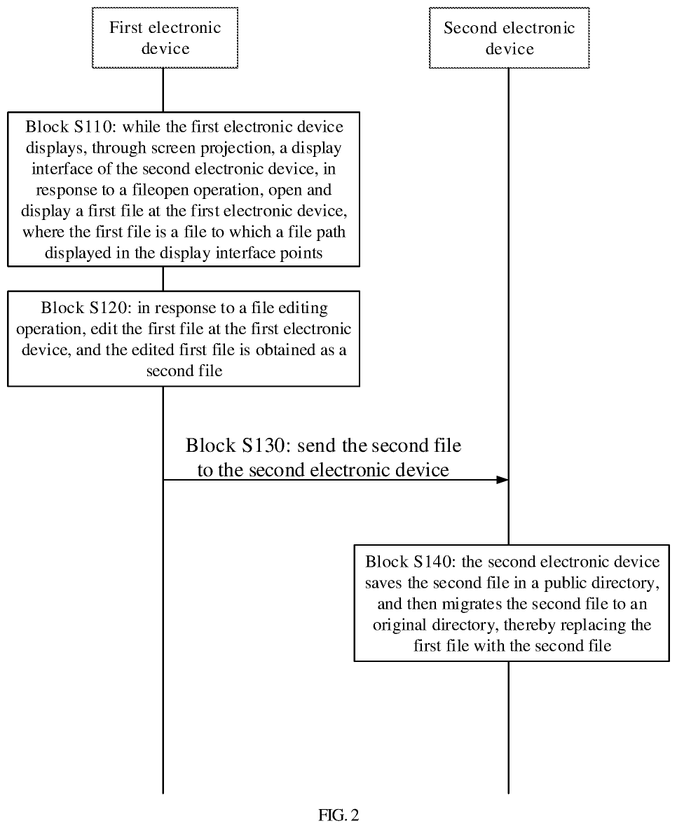

Referring to FIG. 2, a timing diagram of the file saving method provided in the embodiments of the present disclosure is illustrated. The method is applied to a file saving system including the first electronic device and the second electronic device. A flow illustrated in FIG. 2 is described in detail below. The file saving method may specifically include the following operations.

At block S110, while the first electronic device displays, through screen projection, a display interface of the second electronic device, in response to a file open operation, a first file is opened and displayed at the first electronic device, where the first file is a file to which a file path displayed in the display interface points.

In the embodiments, the first electronic device and the second electronic device may perform a WiFi direct connection through cross-screen interconnection software. After a connection for screen projection is established between the first electronic device and the second electronic device, the second electronic device may send screen projection data to the first electronic device. The screen projection data includes a real-time video stream, that is, the screen projection data includes the display interface of the second electronic device. When the display interface of the second electronic device is a desktop of the second electronic device, the screen projection data is the desktop of the second electronic device. When the display interface of the second electronic device is an application page, the screen projection data is the application page of the second electronic device. Of course, when the display interface of the second electronic device changes, the screen projection data may change accordingly. In some embodiments, the first electronic device may generate, according to the screen projection data sent from the second electronic device, a collaboration window on a screen of the first electronic device, where the collaboration window is configured to display a screen projection interface that the second electronic device projects onto the first electronic device, that is, the collaboration window is configured to display the display interface of the second electronic device.

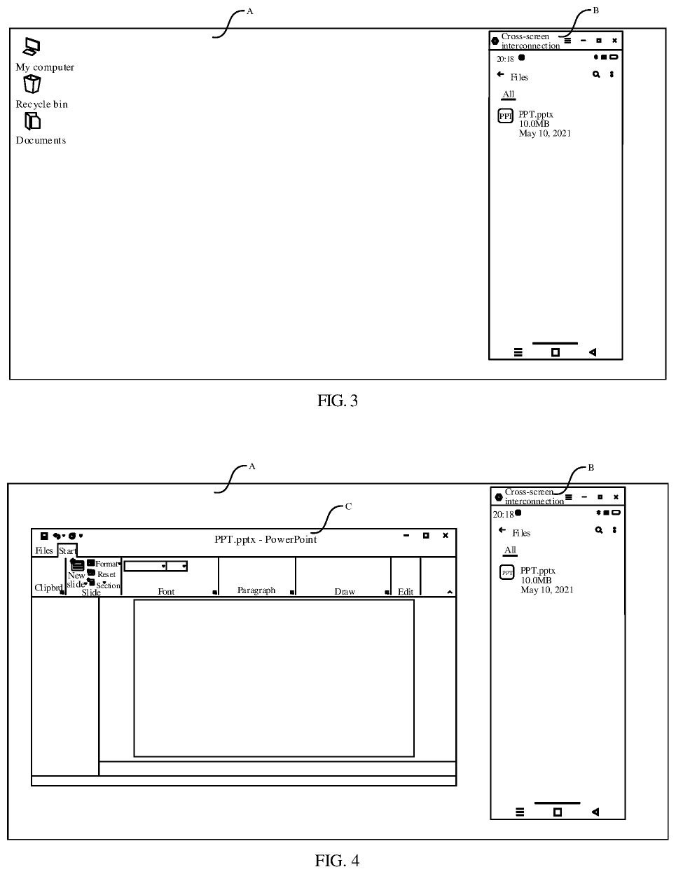

Referring to FIG. 3, a schematic diagram of a first interface of the first electronic device provided in the embodiments of the present disclosure is illustrated. As illustrated in FIG. 3, the display interface B of the second electronic device is displayed, through screen projection, on the interface A of the first electronic device. The display interface B of the second electronic device may be displayed, through screen projection, on the interface A of the first electronic device at a fixed position (immovable), or the display interface B may be displayed, through screen projection on the interface A of the first electronic device at a dynamic position (movable).

As a way, when the first electronic device displays, through screen projection, the display interface of the second electronic device, the user may operate the second electronic device to process the display interface. For example, the user may operate the second electronic device to control the display interface to change (such as exit the application page and enter the desktop), the user may operate the second electronic device to open a certain file in the display interface, or the user may further operate the second electronic device to close a certain file in the display interface and so on, which is not limited here. At this time, the display interface of the second electronic device, which is displayed through screen projection at the first electronic device, is updated synchronously.

As another way, when the first electronic device displays, through screen projection, the display interface of the second electronic device, the user may operate the first electronic device to process the display interface. For example, the user may operate the first electronic device to control the display interface to change (such as exit the application page and entering the desktop), the user may operate the first electronic device to open a certain file in the display interface, or the user may further operate the first electronic device to close a certain file in the display interface and so on, which is not limited here.

Of course, during a process that the display interface of the second electronic device is displayed, through screen projection, on an interface of the first electronic device, the interface of the first electronic device may further change. For example, the interface of the first electronic device may further be switched from the desktop to an application page, which is not limited here.

In some implementations, the display interface of the second electronic device may be a file management interface, and a file path to a file is displayed in the display interface. The number of the file paths displayed in the display interface may be one or more. When there is one file path displayed in the display interface, the file path displayed in the display interface is the file path to the first file. When there are multiple file paths displayed in the display interface, the multiple file paths displayed in the display interface include the file path to the first file and file paths to other files.

In the embodiments, while the first electronic device displays, through screen projection, the display interface of the second electronic device, an operation for the display interface may be detected. When a file open operation for the display interface is detected, the first file may be opened and displayed at the first electronic device. The opening and displaying the first file at the first electronic device refers to opening and displaying the first file with local software of the first electronic device. For example, when the first file is a word file, the first file may be opened and displayed with local word viewing software of the first electronic device. When the first file is an excel file, the first file may be opened and displayed with a local Excel viewing software of the first electronic device.

Referring to FIG. 4, a schematic diagram of a second interface of the first electronic device provided in the embodiments of the present disclosure is illustrated. As illustrated in FIG. 4, the display interface B of the second electronic device is displayed, through screen projection, on the interface A of the first electronic device. When the file open operation for the display interface is detected, the first file C may be opened and displayed at the first electronic device.

As a way, when the first electronic device is a desktop computer, the file open operation may be triggered by a peripheral device connected with the first electronic device, for example, it may be triggered by a mouse connected with the first electronic device. Specifically, when the first electronic device displays, through screen projection, the display interface of the second electronic device, if it is detected that the file path to the first file displayed in the display interface is clicked by the mouse, the first file may be opened and displayed, in response to the clicking operation, in the first electronic device.

As a further way, when the first electronic device is a tablet computer, the file open operation may be directly triggered by the user, for example, it may be triggered by a click operation performed with a finger of the user. Specifically, when the first electronic device displays, through screen projection, the display interface of the second electronic device, if it is detected that the user clicks the file path to the first file displayed in the display interface, the first file may be opened and displayed, in response to the click operation, in the first electronic device.

At block S120, in response to a file editing operation, the first file is edited at the first electronic device, and the edited first file is obtained as a second file.

In the embodiments, while the first electronic device displays the first file, an operation for the first file may be detected. When a file editing operation for the first file is detected, the first file may be edited, in response to the file editing operation, at the first electronic device, and the edited first file is obtained as the second file. The editing the first file may include deleting a content from the first file, adding a content to the first file, modifying the content of the first file and the like, which is not limited here.

At block S130, the second file is sent to the second electronic device.

In the embodiments, after obtaining the second file, the first electronic device may send the second file to the second electronic device. For example, the first electronic device may send the second file to the second electronic device through the WLAN.

As a way, after obtaining the second file, the first electronic device may directly/immediately send the second file to the second electronic device.

As another way, after a preset time has elapsed since the second file is obtained, the first electronic device may send the second file to the second electronic device.

As a further way, after obtaining the second file, the first electronic device may send, in response to a file saving operation, the second file to the second electronic device.

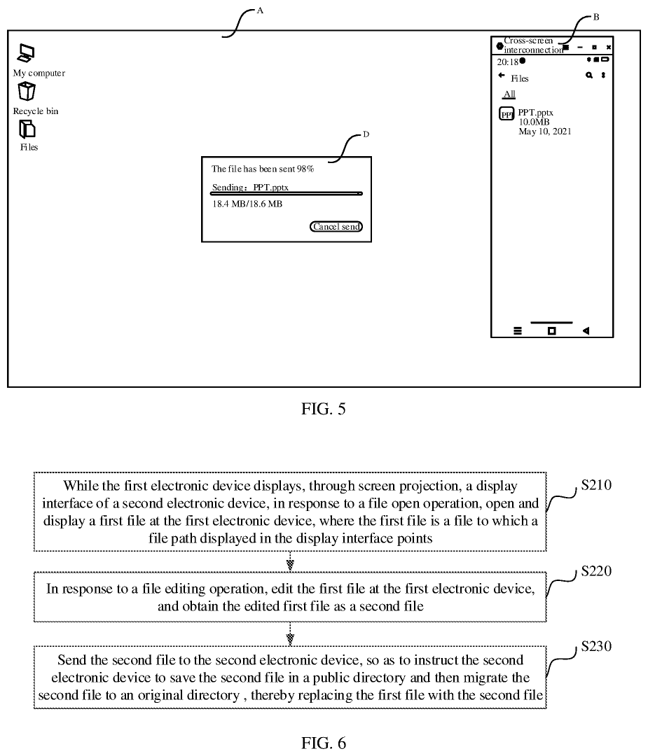

Referring to FIG. 5, a schematic diagram of a third interfere of the first electronic device provided in the embodiments of the present disclosure is illustrated. As illustrated in FIG. 5, the display interface B of the second electronic device is displayed, through screen projection, on the interface A of the first electronic device. In a process that the first electronic device sends the second file to the second electronic device, a sending progress bar D may further be displayed to show a sending progress of the second file.

At block S140, the second electronic device saves the second file in a public directory, and then migrates the second file to an original directory of the first file, thereby replacing the first file with the second file.

In the embodiments, after receiving the second file sent from the first electronic device, the second electronic device may first save the second file in the public directory of the second electronic device, and then migrate the saved second file from the public directory to the original directory of the first file, thereby replacing the first file with the second file. The second electronic device includes a private directory and the public directory, in which access to the private directory requires permission, whereas access to the public directory does not require permission. Therefore, since the second electronic device first saves the second file in the public directory and then migrates the second file to the original directory, which may avoid a problem of lacking read and write access to the file, and enables a file in any directory to be saved, across ends, back in the second electronic device.

In some embodiments, the second electronic device may include an interconnection central control Synergy and a file manager FileManager, where Synergy may read and write any file to and from the public directory without permission, and the file FileManager has read and write access to all files. After obtaining the second file, the first electronic device may transfer the second file to Synergy through service defined by an intelligent connection distribution framework ICDF. Synergy saves the second file in the public directory, and then Synergy informs FileManager to perform file migration. FileManager may then migrate the second file saved in the public directory to the original directory of the first file, thereby replacing the first file with the second file.

In the file saving method provided in the embodiments of the present disclosure, a file edited at the first electronic device is sent to the second electronic device, and it is first saved in the public directory, and then migrated to the original directory. This avoids the problem of lacking read and write access to a file, and enables editing, at the first electronic device cross ends, of a file in any directory of the second electronic device, and saving of the edited file back to the second electronic device. As such, the success rate of saving of the file cross ends is improved.

Referring to FIG. 6, a schematic flowchart of a file saving method provided in an embodiment of the present disclosure is illustrated. The method is applied to the first electronic device, and the flow illustrated in FIG. 6 is described in detail below. The file saving method may specifically include the following operations.

At block S210, while the first electronic device displays, through screen projection, a display interface of a second electronic device, in response to a file open operation, a first file is opened and displayed at the first electronic device, where the first file is a file to which a file path displayed in the display interface points.

At block S220, in response to a file editing operation, the first file is edited at the first electronic device, and the edited first file is obtained as a second file.

At block S230, the second file is sent to the second electronic device, so as to instruct the second electronic device to save the second file in a public directory and then migrate the second file to an original directory of the first file, thereby replacing the first file with the second file.

For the detailed description of blocks S210-S230, reference may be made to blocks S110-S140, which are not repeated here.

In the file saving method provided in the embodiment of the present disclosure, a file edited at the first electronic device is sent to the second electronic device, and it is first saved in the public directory and then migrated to the original directory. This avoids the problem of lacking read and write access to a file, and enables editing, at the first electronic device cross ends, of a file in any directory of the second electronic device, and saving of the edited file back to the second electronic device. As such, the success rate of saving the file cross ends is improved.

Referring to FIG. 7, a schematic flowchart diagram of a file saving method provided in another embodiment of the present disclosure is illustrated. The method is applied to the above-mentioned first electronic device, and the flow illustrated in FIG. 7 is described in detail below. The file saving method may specifically include the following operations.

At block S310, while the first electronic device displays, through screen projection, a display interface of a second electronic device, in response to a file open operation, a first file is opened and displayed at the first electronic device, where the first file is a file to which a file path displayed in the display interface points.

At block S320, in response to a file editing operation, the first file is edited at the first electronic device, and the edited first file is obtained as a second file.

For the detailed description of blocks S310-S320, reference may be made to blocks S110-S120, which are repeated here.

At block S330, in response to a file saving operation, the second file is sent to the second electronic device, so as to instruct the second electronic device to save the second file in a public directory and then migrate the second file to an original directory of the first file, thereby replacing the first file with the second file.

In the embodiment, after obtaining the second file, the first electronic device may detect an operation for the second file. When the file saving operation for the second file is detected, the second file may be sent, in response to the file saving operation, to the second electronic device. The first electronic device may send, in response to the file saving operation, the second file to the second electronic device without saving the second file locally, so as to reduce the occupation of a storage space of the first electronic device.

Compared with the file saving method illustrated in FIG. 6, in the file saving method provided in this embodiment of the present disclosure, when detecting the file saving operation, the first electronic device sends the second file to the second electronic device, which may avoid mistransmission and erroneous saving of the file.

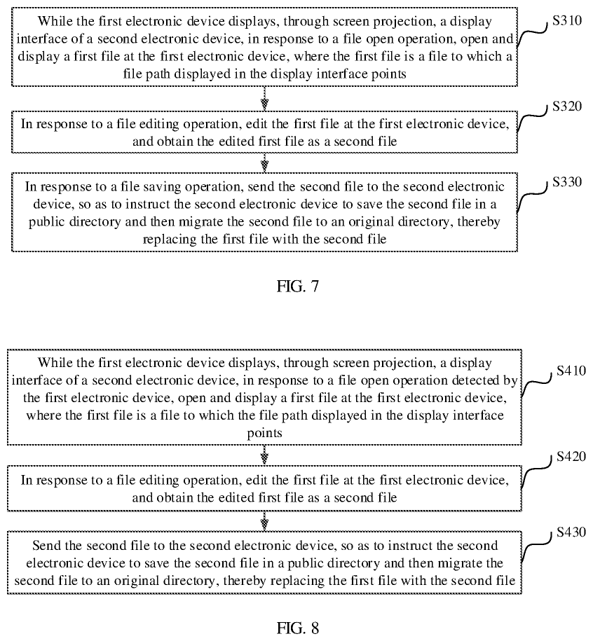

Referring to FIG. 8, a schematic flowchart of a file saving method provided in a further embodiment of the present disclosure is illustrated. The method is applied to the above-mentioned first electronic device, and the flow illustrated in FIG. 8 is described in detail below. The file saving method may specifically include the following operations.

At block S410, while the first electronic device displays, through screen projection, a display interface of a second electronic device, in response to a file open operation detected by the first electronic device, a first file is opened and displayed at the first electronic device, where the first file is a file to which the file path displayed in the display interface points.

In some embodiments, while the first electronic device displays, through screen projection, the display interface of the second electronic device, an operation for the display interface may be detected. When the file open operation for the display interface is detected, it may be determined whether the file open operation is detected by the first electronic device or by the second electronic device. When it is determined that the file open operation is detected by the first electronic device, it is indicated that the file open operation is triggered at the first electronic device. Accordingly, the first file may be opened and displayed at the first electronic device, in response to the file open operation detected by the first electronic device. As such, a side on which the file is opened may be determined by detecting a side on which the file open operation is triggered, and the efficiency and rationality of opening and displaying the file may be effectively improved.

At block S420, in response to a file editing operation, the first file is edited at the first electronic device, and the edited first file is obtained as a second file.

At block S430, the second file is sent to the second electronic device, so as to instruct the second electronic device to save the second file in a public directory and then migrate the second file to an original directory of the first file, thereby replacing the first file with the second file.

For the detailed description of blocks S420-S430, reference may be made to blocks S120-S140, which are not repeated here.

Compared with the file saving method illustrated in FIG. 6, in the file saving method provided in a further embodiment of the present disclosure, when the file open operation is detected by the first electronic device, the first file is opened and displayed at the first electronic device. That is, the side on which the file is opened is determined by detecting the side on which the file open operation is triggered, which avoids the user from manually selecting the side on which the file is opened, and the efficiency and rationality of opening and displaying the file can be effectively improved.

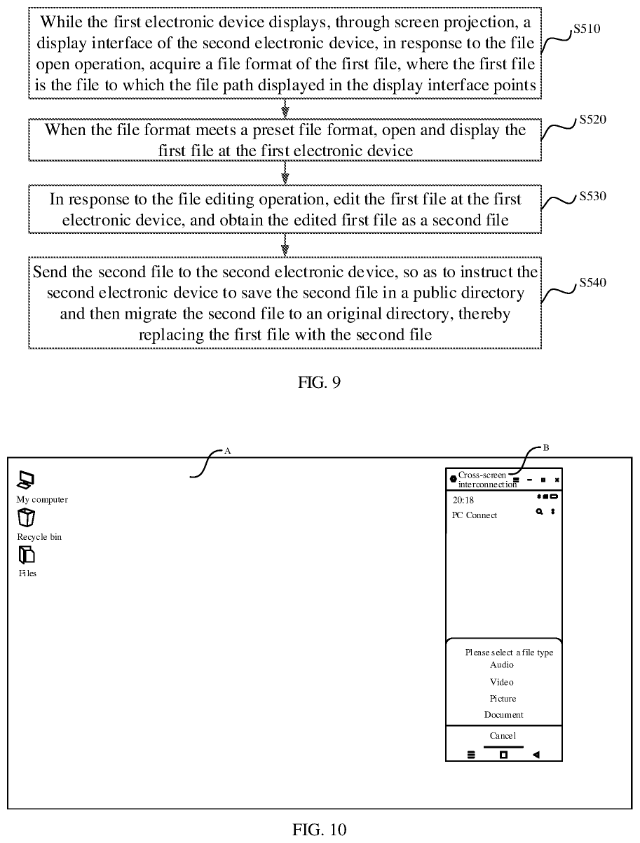

Referring to FIG. 9, a schematic flowchart of a file saving method provided in yet a further embodiment of the present disclosure is illustrated. The method is applied to the above-mentioned first electronic device, and the flow illustrated in FIG. 9 is described in detail below. The file saving method may specifically include the following operations.

At block S510, while the first electronic device displays, through screen projection, a display interface of the second electronic device, in response to the file open operation, a file format of the first file is acquired, where the first file is the file to which the file path displayed in the display interface points.

In the embodiments, while the first electronic device displays, through screen projection, the display interface of the second electronic device, an operation for the display interface may be detected. When the file open operation for the display interface is detected, the file format of the first file may be acquired. As a way, when the file open operation for the display interface is detected, a suffix of the first file may be obtained, and the file format of the first file may be acquired based on the suffix of the first file.

At block S520, when the file format meets a preset file format, the first file is opened and displayed at the first electronic device.

In some embodiments, the first electronic device may be preset and stored with the preset file format, and the preset file format serves as a determination basis for the file format of the first file. Therefore, in the embodiment, after the file format of the first file is obtained, the file format of the first file may be compared with the preset file format, so as to determine whether the file format of the first file meets the preset file format, thereby obtaining a determination result. When the determination result indicates that the file format of the first file meets the preset file format, it may be construed that the first file is not a virus file, and then the first file may be opened and displayed at the first electronic device. When the determination result indicates that the file format of the first file does not meet the preset file format, it may be construed that the first file is a suspected virus file, and the first file may not be opened in the first electronic device.

As a way, the preset file format may include a picture format, a video format, an audio format, a compressed package format, a document format, etc., which is not limited here.

In some embodiments, when the file open operation for the display interface is detected, the first electronic device may further display the preset file formats, and the user may select one of the preset file formats to open the first file. If the file format of the first file does not meet the preset file format, the first file may not be opened.

Referring to FIG. 10, a schematic diagram of a fourth interface of the first electronic device provided in the embodiments of the present disclosure is illustrated. As illustrated in FIG. 10, the display interface B of the second electronic device is displayed, through screen projection, on the interface A of the first electronic device. When a file open operation for the display interface is detected, preset file formats (such as audio, video, picture and document) may be displayed in the display interface for the user to select. In addition, a cancel button may be displayed, which is used to cancel the display of the preset file formats in the display interface.

At block S530, in response to the file editing operation, the first file is edited at the first electronic device, and the edited first file is obtained as a second file.

At block S540, the second file is sent to the second electronic device, so as to instruct the second electronic device to save the second file in the public directory and then migrate the second file to an original directory of the first file, thereby replacing the first file with the second file.

For the detailed description of blocks S530-S540, reference may be made to blocks S120-S140, which are not repeated here.

Compared with the file saving method illustrated in FIG. 6, in the file saving method provided in yet a further embodiment of the present disclosure, only when the file format of the first file meets the preset file format, the first file is opened and displayed at the first electronic device, which can improve the security of the first electronic device.

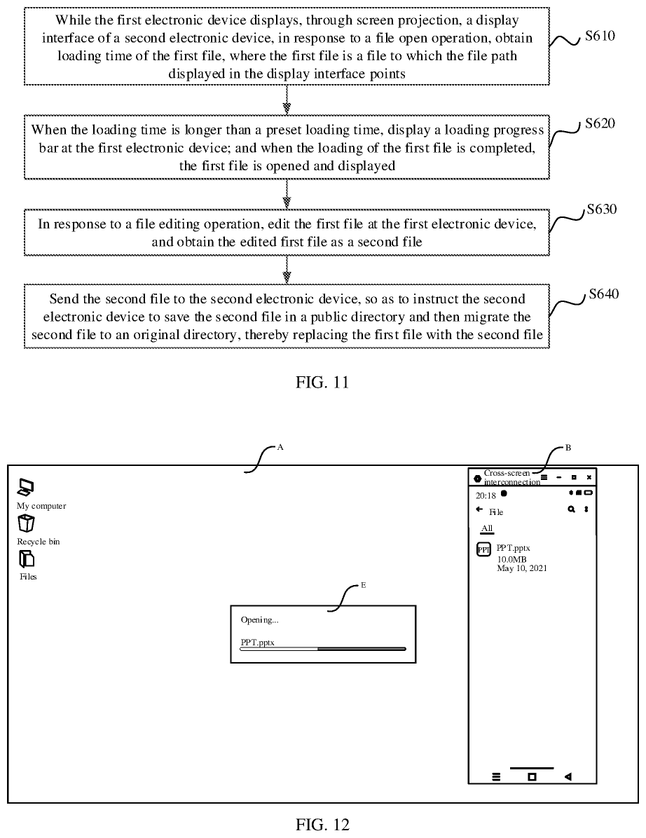

Referring to FIG. 11, a flowchart of a file saving method provided in yet a still further embodiment of the present disclosure is illustrated. The method is applied to the above-mentioned first electronic device, and the flow illustrated in FIG. 11 is described in detail below. The file saving method may specifically include the following operations.

At block S610, while the first electronic device displays, through screen projection, a display interface of a second electronic device, in response to a file open operation, a loading time of the first file is obtained, where the first file is a file to which the file path displayed in the display interface points.

In the embodiments, while the first electronic device displays, through screen projection, the display interface of the second electronic device, the operation for the display interface may be detected. When the file open operation for the display interface is detected, the loading time of the first file may be obtained.

As a way, when the file open operation for the display interface is detected, the file size of the first file may be obtained, and the loading time of the first file may be determined according to the file size of the first file.

As another way, when the opening operation for the display interface is detected, the file size of the first file and performance of a processor of the first electronic device may be obtained, and the loading time of the first file may be determined according to the file size of the first file and the performance of the processor of the first electronic device.

As another way, when the opening operation for the display interface is detected, the file size of the first file, the performance of the processor of the first electronic device and a load rate of the processor of the first electronic device may be obtained, and the loading time of the first file may be determined according to the file size of the first file, the performance of the processor of the first electronic device and the load rate of the processor of the first electronic device.

At block S620, when the loading time is longer than a preset loading time, a loading progress bar is displayed at the first electronic device; and when the loading of the first file is completed, the first file is opened and displayed.

In some embodiments, the first electronic device may be preset and stored with the preset loading time, the preset loading time serves as a determination basis for the loading time of the first file. Therefore, in the embodiment, after the loading time of the first file is obtained, the loading time of the first file may be compared with the preset loading time, so as to determine whether the loading time of the first file is greater than the preset loading time, thereby obtaining a determination result. When the determination result indicates that the loading time of the first file is longer than the preset loading time, it shows that the loading of the first file needs to be waited, the loading progress bar may be displayed at the first electronic device, and the first file may be opened and displayed upon completion of the loading of the first file. When the determination result indicates that the loading time of the first file is not longer than the preset loading time, it shows that the loading of the first file does not need to be waited, and the first file may be directly opened and displayed without displaying the loading progress bar at the first electronic device.

As a way, the preset loading time may include 1 s, 2 s, etc., which is not limited here.

Referring to FIG. 12, a schematic diagram of a fifth interface of the first electronic device provided in the embodiments of the present disclosure is illustrated. As illustrated in FIG. 12, the display interface B of the second electronic device is displayed, through screen projection, on the interface A of the first electronic device. When the loading time of the first file is longer than the preset loading time, a loading progress bar E may be displayed at the first electronic device.

At block S630, in response to a file editing operation, the first file is edited at the first electronic device, and the edited first file is obtained as a second file.

At block S640, the second file is sent to the second electronic device, so as to instruct the second electronic device to save the second file in a public directory and then migrate the second file to an original directory of the first file, thereby replacing the first file with the second file.

For the detailed description of blocks S630-S640, reference may be made to blocks S120-S140, which are not repeated here.

Compared with the file saving method illustrated in FIG. 6, in the file saving method provided in yet a still further embodiment of the present disclosure, the loading progress bar is displayed at the first electronic device when the loading time of the first file is longer than the preset loading time, so as to avoid the user's uncertainty while waiting for the loading of the file, and thus improve the user experience.

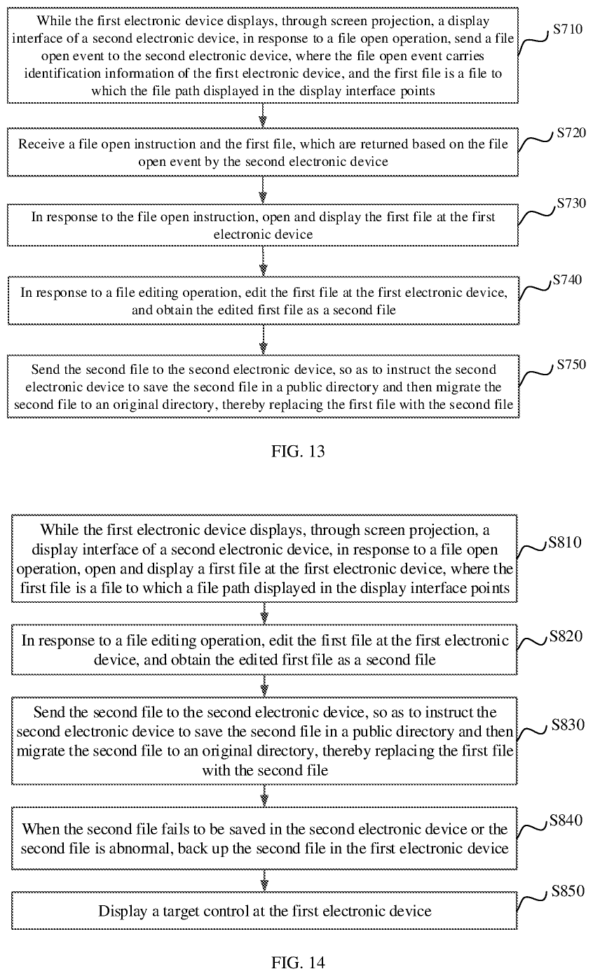

Referring to FIG. 13, a schematic flowchart of a file saving method provided in yet a still further embodiment of the present disclosure is illustrated. The method is applied to the first electronic device mentioned above, and the flow illustrated in FIG. 13 is described in detail below. The file saving method may specifically include the following operations.

At block S710, while the first electronic device displays, through screen projection, a display interface of a second electronic device, in response to a file open operation, a file open event is sent to the second electronic device, where the file open event carries identification information of the first electronic device, and the first file is a file to which the file path displayed in the display interface points.

In some implementations, the second electronic device may include an interconnection central control Synergy, a user input back channel UICB, and a file manager FileManager. After the display interface of the second electronic device is displayed, through screen projection, at the first electronic device, when the first electronic device detects the file open operation, the first electronic device may send, to the second electronic device, the file open event carrying the identification information of the first electronic device. The identification information may include a physical address, identity information, etc., which is not limited here.

In some implementations, when the first electronic device detects the file open operation, in response to the file open operation, a file open event may be generated, and then the file open event is injected into the system of the second electronic device and converted into a file open event of the second electronic device.

At block S720, a file open instruction and the first file, which are returned based on the file open event by the second electronic device, are received.

In some implementations, after receiving the file open event sent by the first electronic device, the second electronic device may generate, based on the file open event, the file open instruction and the first file, and send the file open instruction and the first file to the first electronic device. Accordingly, the first electronic device receives the file open instruction and the first file.

As a way, when the FileManager of the second electronic device receives the file open event, the first file may be shared with Synergy, and Synergy may send the first file to the first electronic device through the intelligent connection distribution framework ICDF. Moreover, Synergy may further send the file open instruction to the first electronic device. Accordingly, the first electronic device may receive the file open instruction and the first file.

As another way, when the FileManager of the second electronic device receives the file open event, it may be determined whether the file open event is detected by the first electronic device. If the file open event is detected by the first electronic device, the first file may be shared with Synergy, and Synergy sends the first file to the first electronic device through the intelligent connection distribution framework ICDF. Moreover, Synergy may further send the file open instruction to the first electronic device. Accordingly, the first electronic device may receive the file open event and the first file.

As a way, when the FileManager of the second electronic device receives the file open event, it may be determined whether the file format of the first file indicated by the file open event meets a preset file format. If it is determined that the file format of the first file meets the preset file format, the first file may be shared with Synergy, and Synergy sends the first file to the first electronic device through the intelligent connection distribution framework ICDF. Moreover, Synergy may further send the file open instruction to the first electronic device. Accordingly, the first electronic device may receive the file open instruction and the first file.

At block S730, in response to the file open instruction, the first file is opened and displayed at the first electronic device.

At block S740, in response to a file editing operation, the first file is edited at the first electronic device, and the edited first file is obtained as a second file.

At block S750, the second file is sent to the second electronic device, so as to instruct the second electronic device to save the second file in a public directory and then migrate the second file to an original directory of the first file, thereby replacing the first file with the second file.

For detailed descriptions of blocks S730-S750, reference may be made to blocks S110-S140, which are not repeated here.

Compared with the file saving method illustrated in FIG. 6, in the file saving method provided in yet a still further embodiment of the present disclosure, the file open event is sent to the second electronic device when the file open operation is detected, and the file open instruction and the first file returned by the second electronic device based on the file open event are received, thereby improving the acquisition, opening and displaying of the file cross ends.

Referring to FIG. 14, a flowchart of a file saving method provided in yet a still further embodiment of the present disclosure is illustrated. The method is applied to the first electronic device mentioned above, and the flow illustrated in FIG. 14 is described in detail below. The file saving method may specifically include the following operations.

At block S810, while the first electronic device displays, through screen projection, a display interface of a second electronic device, in response to a file open operation, a first file is opened and displayed at the first electronic device, where the first file is a file to which a file path displayed in the display interface points.

At block S820, in response to a file editing operation, the first file is edited at the first electronic device, and the edited first file is obtained as a second file.

At block S830, the second file is sent to the second electronic device, so as to instruct the second electronic device to save the second file in a public directory and then migrate the second file to an original directory of the first file, thereby replacing the first file with the second file.

For detailed descriptions of blocks S810-S830, reference may be made to blocks S110-S140, which are not repeated here.

At block S840, when the second file fails to be saved in the second electronic device or the second file is abnormal at the second electronic device, the second file is backed up in the first electronic device.

In the embodiments, after the first electronic device sends the second file to the second electronic device, the status of the second file may be monitored. As a way, the first electronic device and the second electronic device remain the connection therebetween, and the first electronic device may monitor, after sending the second file to the second electronic device, a message returned by the second electronic device. When the second electronic device returns a first message, it may be construed that the second file is successfully saved in the second electronic device. When the second electronic returns a second message, it may be construed that the second file failed to be saved. When the second electronic device returns a third message, it may be construed that the second file was successfully saved to the second electronic device but abnormality occurred (such as abnormality occurring in opening).

In some embodiments, when the second file fails to be saved in the second electronic device, or the second file is saved successfully in the second electronic device but the abnormality occurs, the second file may be backed up in the first electronic device, so as to avoid the loss of the second file.

At block S850, a target control is displayed at the first electronic device.

In some embodiments, after the first electronic device backs up the second file, the target control may be displayed at the first electronic device, where the target control may be configured to prompt that the second file has been backed up in the first electronic device. For example, after the first electronic device backs up the second file, the target control may be popped up.

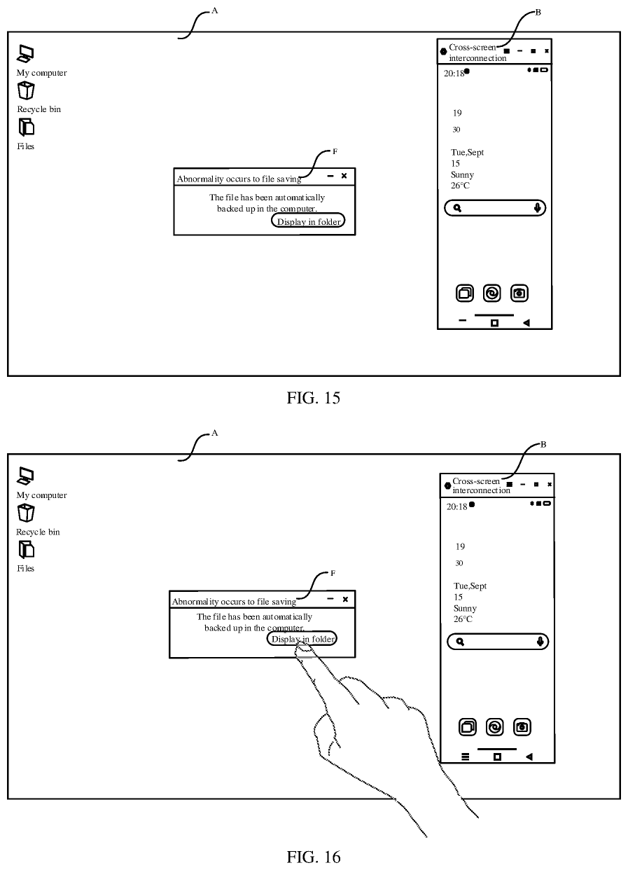

Referring to FIG. 15, a schematic diagram of a fifth interface of the first electronic device provided in the embodiments of the present disclosure is illustrated. As illustrated in FIG. 15, the display interface B of the second electronic device is displayed, through screen projection, on the interface A of the first electronic device. When the second file is unsuccessfully saved in the second electronic device, or the second file is successfully saved in the second electronic device but the abnormality occurs, the target control F may be displayed at the first electronic device.

At block S860, when a touch operation performed on the target control is detected, a folder in which the second file is backed up is jumped to in the first electronic device.

In some embodiments, while the first electronic device displays the target control, the first electronic device may detect the touch operation for the target control. When the touch operation performed on the target control is detected, it may jump, in the first electronic device, to the folder in which the second file is backed up, that is, the target control may be construed as an entrance to the folder in which the second file is backed up. When the touch operation performed on the entrance is detected, the folder in which the second file is backed up is displayed at the first electronic device. As such, the user is enabled to quickly locate the backed up second file.

In some embodiments, while the first electronic device displays, through screen projection, the target control, if no touch operation performed on the target control is detected until a display duration for the target control reaches a specified duration, the target control may be deleted. In addition, within a preset time before deleting the target control, a prompt sound may further be output to prompt the user.

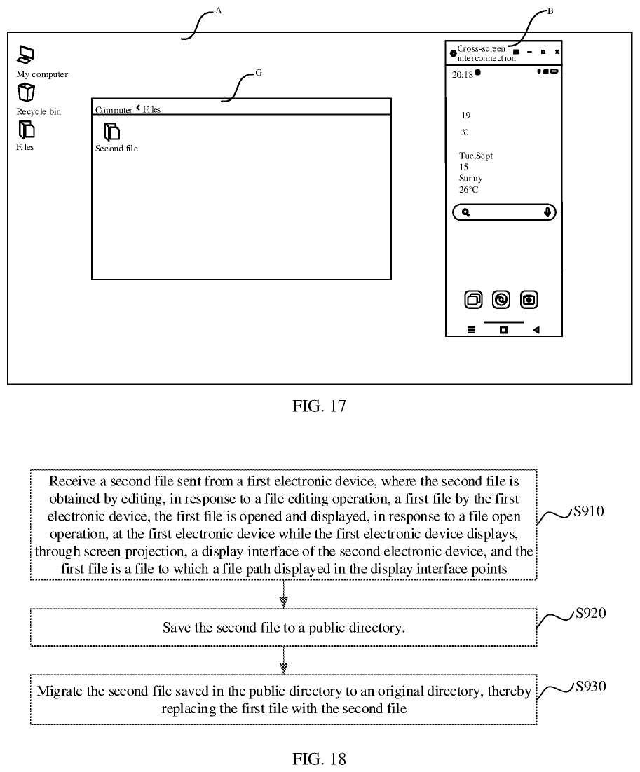

Referring to FIG. 16 and FIG. 17, a first schematic interaction diagram provided in the embodiments of the present disclosure is illustrated in FIG. 16, and schematic diagram of a sixth interface of the first electronic device provided in the embodiments of the present disclosure is illustrated in FIG. 17. As illustrated in FIG. 16, while the first electronic device displays the target control F, when the touch operation performed on the target control F is detected, it may jump, in the first electronic device, to the folder G in which the second file is backed up (FIG. 17).

Compared with the file saving method illustrated in FIG. 6, in the file saving method provided in yet a still further embodiment of the present disclosure, when the second file fails to be saved in the second electronic device or the second file is abnormal, the second file is further backed up in the first electronic device, so as to avoid the loss of the second file. In addition, the target control for locating a saving position of the second file is displayed, to improve the efficiency of searching the second file by the user.

Referring to FIG. 18, a flowchart of a file saving method provided in yet a still further embodiment of the present disclosure is illustrated in FIG. 18. The method is applied to the above-mentioned second electronic device, and the flow illustrated in FIG. 18 is described in detail below. The file saving method may specifically include the following operations.

At block S910, a second file sent from a first electronic device is received, where the second file is obtained by editing, in response to a file editing operation, a first file by the first electronic device, the first file is opened and displayed, in response to a file open operation, at the first electronic device while the first electronic device displays, through screen projection, a display interface of the second electronic device, and the first file is a file to which a file path displayed in the display interface points.

In some embodiments, while the second electronic device displays the display interface including at least the file path to the first file, an operation for the display interface may be detected. When the file open operation for the display interface is detected, it may be determined whether the file open operation is detected by the first electronic device or by the second electronic device. When it is determined that the file open operation is detected by the second electronic device, it shows that the file open operation is triggered at the second electronic device; then, in response to the file open operation detected by the second electronic device, the first file may be opened and displayed at the second electronic device. That is, a side on which the file is opened may be determined by detecting side on which the file open operation is triggered, which may effectively improve the efficiency and rationality of the opening and displaying of the file.

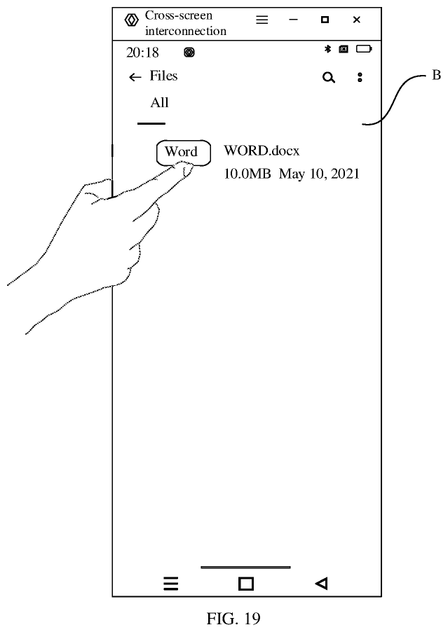

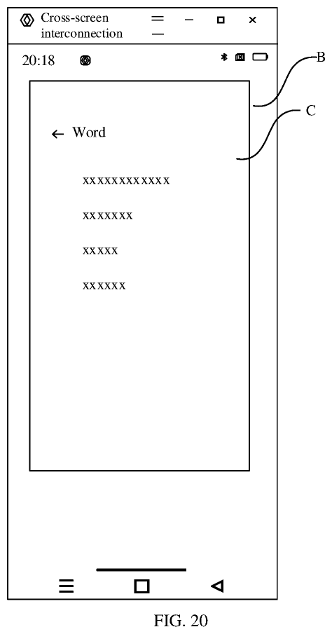

Referring to FIG. 19 and FIG. 20, a second schematic interaction diagram provided in the embodiments of the present disclosure is illustrated in FIG. 19, and a schematic diagram of an interface of the second electronic device provided in the embodiments of the present disclosure is illustrated in FIG. 20. As illustrated in FIG. 19, the second electronic device displays the display interface B. When the second electronic device detects the file open operation for the display interface, the second file C may be opened and displayed on the second electronic device (FIG. 20).

At block S920, the second file is saved to a public directory.

At block S930, the second file saved in the public directory is migrated to an original directory of the first file, thereby replacing the first file with the second file.

For detailed descriptions of blocks S910-S930, reference may be made to blocks S110-S140, which are not repeated here.

According to the file saving method provided in yet a still further embodiment of the present disclosure, the file edited by the first electronic device is sent to the second electronic device, so as to be saved in the public directory first and then moved to the original directory of the first file, which avoids the problem of lacking read and write access to the file, and enables editing, at the first electronic device cross ends, of a file in any directory of the second electronic device, and saving of the edited file back to the second electronic device. As such, the success rate of saving the file cross ends may be improved.

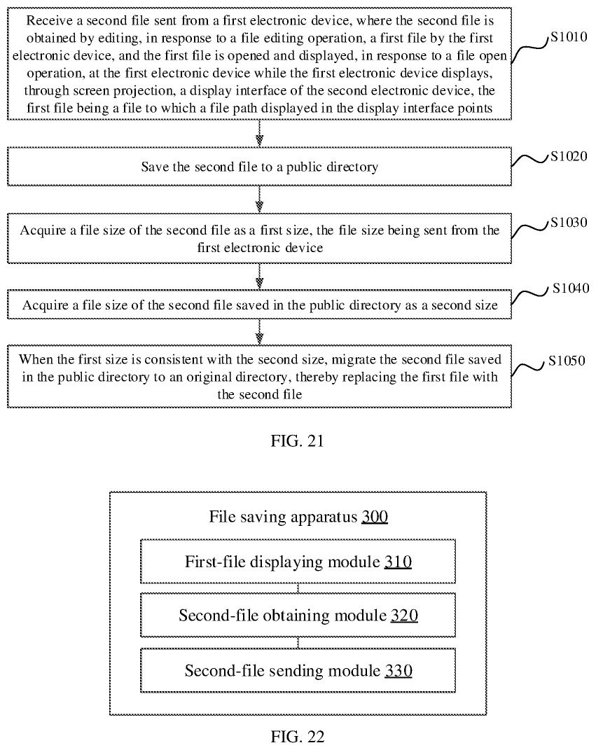

Referring to FIG. 21, a flowchart of a file saving method provided in yet a still further embodiment of the present disclosure is illustrated. The method is applied to the above-mentioned second electronic device, and the flow illustrated in FIG. 21 is described in detail below. The file saving method may specifically include the following operations.

S1010, a second file sent from a first electronic device is received, where the second file is obtained by editing, in response to a file editing operation, a first file by the first electronic device, and the first file is opened and displayed, in response to a file open operation, at the first electronic device while the first electronic device displays, through screen projection, a display interface of the second electronic device, the first file being a file to which a file path displayed in the display interface points.

S1020, the second file is saved to a public directory.

For detailed descriptions of blocks S1010-S1020, reference may be made to blocks S110-S140, which are not repeated here.

S1030, a file size of the second file is acquired as a first size, the file size being sent from the first electronic device.

In some implementations, when the first electronic device sends the second file to the second electronic device, the first electronic device may further send the file size of the second file to the second electronic device. Accordingly, the second electronic device may acquire the file size of the second file sent from the first electronic device as the first size.

In some implementations, when the first electronic device sends the second file to the second electronic device, it may also send a file size and a file saving instruction of the second file to the second electronic device. Accordingly, the second electronic device may obtain the file saving instruction and the file size of the second file that are sent from the first electronic device, and take the received file size as the first size.

At block S1040, a file size of the second file saved in the public directory is acquired as a second size.

In some embodiments, after saving the second file in the public directory, the second electronic device may acquire the file size of the second file saved in the public directory, as the second size. As a way, after saving the second file in the public directory, the second electronic device may acquire a size of a storage space occupied by the second file saved to the public directory, and determine, based on the size of the storage space, the file size of the second file saved to the public directory as the second size.

At block S1050, when the first size is consistent with the second size, the second file saved in the public directory is migrated to the original directory, thereby replacing the first file with the second file.

In some embodiments, after acquiring the first size and the second size, the second electronic device may compare the first size and the second size to determine whether the first size and the second size are consistent with each other. When the first size and the second size are consistent, it is indicated that the second file is normally stored in the public directory, and the second file stored in the public directory may be migrated to the original directory of the first file, thereby replacing the first file with the second file. When the first size and the second size are inconsistent, it is indicated that the second file stored in the public directory is abnormal, and the first electronic device may be request to re-send the second file.

Compared with the file saving method illustrated in FIG. 18, in the file saving method provided in yet a still further embodiment of the present disclosure, when the file size of the second file saved to the public directory of the second electronic device is consistent with the file size of the second file sent from the first electronic device, that is, when it is determined that no lost occurs for the saved file, the second file saved to the public directory is migrated to the original directory, so as to determine the accuracy of saving the file cross ends.

Referring to FIG. 22, a block diagram of a file saving apparatus provided in an embodiment of the present disclosure is illustrated. The file saving apparatus 300 is applied to the first electronic device mentioned above, which is described below with reference to the block diagram illustrated in FIG. 22. The file saving apparatus 300 includes a first-file displaying module 310, a second-file obtaining module 320 and a second-file sending module 330.

The first-file displaying module 310 is configured to open and display a first file at the first electronic device in response to a file open operation, while the first electronic device displays, through screen projection, a display interface of a second electronic device, where the first file is a file to which a file path displayed in the display interface points.

Further, the first-file displaying module 310 includes a first first-file displaying sub-module.

The first first-file displaying sub-module is configured to open and display the first file at the first electronic device, in response to the file open operation detected by the first electronic device.

Further, the first-file displaying module 310 includes a file format acquisition sub-module and a second first-file displaying sub-module.

The file format acquisition sub-module is configured to acquire a file format of the first file, in response to the file open operation.

A second first-file displaying sub-module is configured to open and display the first file at the first electronic device, when the file format meets a preset file format.

Further, the first-file displaying module 310 includes a loading time acquisition sub-module and a third first-file displaying sub-module.

The loading time acquisition sub-module is configured to acquire a loading time of the first file, in response to the file open operation.

A third first-file displaying sub-module is configured to display a loading progress bar at the first electronic device when the loading time is longer than a preset loading time, and open and display the first file upon completion of the loading of the first file.

Further, the first-file displaying module 310 includes a file open event sending sub-module, a file open instruction receiving sub-module and a fourth first-file displaying sub-module.

The file open event sending sub-module is configured to send a file open event to the second electronic device in response to the file open operation, where the file open event carries identification information of the first electronic device.

Further, the file open event sending sub-module includes a file open event generating unit and a file open event sending unit.

The file open event generating unit is configured to generate the file open event, in response to the file open operation.

The file open event sending unit is configured to inject the file open event into a system of the second electronic device, and make the file open event converted into a file open event of the second electronic device.

The file open instruction receiving sub-module is configured to receive a file open instruction and the first file returned by the second electronic device based on the file open event.

The fourth first-file displaying sub-module is configured to open and display the first file at the first electronic device, in response to the file open instruction.

The second-file obtaining module 320 is configured to edit the first file at the first electronic device in response to a file editing operation, and obtain the edited first file as a second file.

The second-file sending module 330 is configured to send the second file to the second electronic device, so as to instruct the second electronic device to save the second file in a public directory and then migrate the second file to an original directory of the first file, thereby replacing the first file with the second file.

Further, the second-file sending module 330 includes a second-file sending sub-module.

The second-file sending sub-module is configured to send the second file to the second electronic device, in response to a file saving operation.

Further, the file saving apparatus 300 further includes a second-file backup module.

The second-file backup module is configured to back up the second file in the first electronic device, when the second file fails to be saved in the second electronic device or the second file is abnormal.

Further, the file saving apparatus 300 further includes a target control displaying module and a folder jumping module.

The target control displaying module is configured to display a target control at the first electronic device.

The folder jumping module is configured to jump to a folder in which the second file is backed up in the first electronic device, when a touch operation performed on the target control is detected.

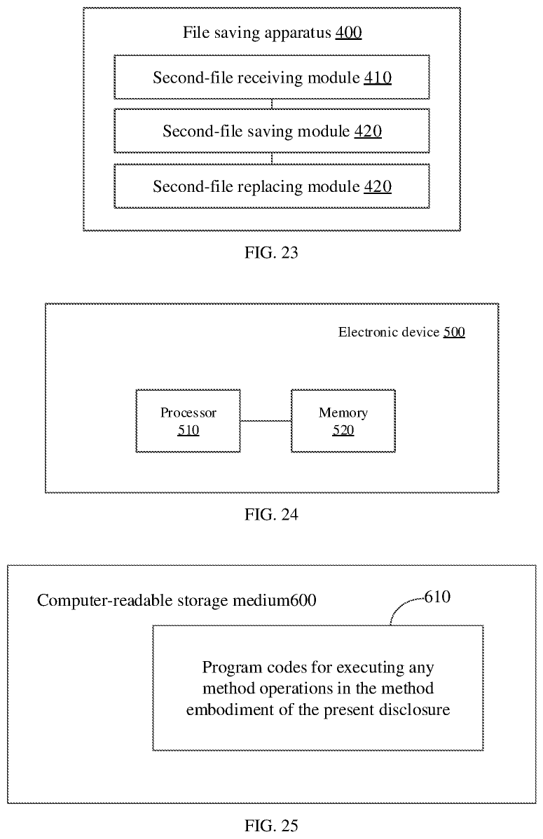

Referring to FIG. 23, a block diagram of a file saving apparatus provided in another embodiment of the present disclosure is illustrated. The file saving apparatus 400 is applied to the second electronic device mentioned above, which is described below with reference to the block diagram illustrated in FIG. 23. The file saving apparatus 400 includes a second-file receiving module 410, a second-file saving module 420 and a second-file replacing module 430.

The second-file receiving module 410 is configured to receive a second file sent from a first electronic device, where the second file is obtained by editing, in response to a file editing operation, a first file by the first electronic device, and the first file is opened and displayed, in response to a file open operation, at the first electronic device while the first electronic device displays, through screen projection, a display interface of the second electronic device, the first file being a file to which a file path displayed in the display interface points.

The second-file saving module 42 is configured to save the second file to a public directory.

The second-file replacing module 430 is configured to migrate the second file saved in the public directory to an original directory of the first file, thereby replacing the first file with the second file.

Further, the second-file replacing module 430 includes a second size acquisition sub-module and a second-file replacement sub-module.

The second size acquisition sub-module is configured to acquire a file size of the second file saved to the public directory as a second size.

The second-file replacing sub-module is configured to, when a first size is consistent with the second size, migrate the second file saved in the public directory to the original directory, thereby replacing the first file with the second file.

Further, the file saving apparatus 400 further includes:
a first size acquisition module, configured to acquire a file size of the second file as a first size, the file size being sent from the first electronic device.

Further, the file saving apparatus 400 further includes a display-interface displaying module and a file open module.

The display-interface displaying module is configured to display the display interface of the second electronic device, where the display interface at least includes the file path to the first file.

The file open module is configured to open and display the first file at the second electronic device, in response to the file open operation detected by the second electronic device.

It may be clearly understandable for those skilled in the art that, for the convenience and conciseness of description, the specific working processes of the apparatuses and modules described above may refer to the corresponding processes in the aforementioned method embodiments, which are not repeated here.

In several embodiments provided in the disclosure, the coupling between modules may be electrical, mechanical or in other forms.

In addition, various functional modules in each embodiment of the present disclosure may be integrated into one processing module, or each module may exist physically alone, or two or more modules may be integrated into one module. The integrated modules above may be realized in the form of hardware or software functional modules.

Referring to FIG. 24, a structural block diagram of an electronic device 500 provided in an embodiment of the present disclosure is illustrated. The electronic device 500 may be the first electronic device 100 or the second electronic device 200, and is not limited here. The electronic device 500 may be an electronic device capable of running application programs, such as a smartphone, a tablet computer, an e-book, etc. The electronic device 500 in the present disclosure may include one or more of the following components: a processor 510, a memory 520, and one or more application programs, where the one or more application programs may be stored in the memory 520 and configured to be executed by the processor 510, and one or more application programs are configured to perform the method as described in the aforementioned method embodiment.

The processor 510 may include one or more processing cores. The processor 510 connects various parts in the whole electronic device 500 with various interfaces and lines, and executes various functions and processes data of the electronic device 100 by running or executing instructions, programs, code sets or instruction sets stored in the memory 520 and calling data stored in the memory 520. Alternatively, the processor 510 may be implemented in at least one hardware of Digital Signal Processing (DSP), Field-Programmable Gate Array (FPGA) and Programmable Logic Array (PLA). The processor 110 may be integrated with one or more of Central Processing Unit (CPU), Graphics Processing Unit (GPU) and modem. CPU mainly deals with operating system, user interface and application programs. GPU is configured to render and draw the content to be displayed. Modems are configured to handle wireless communication. It may be understood that the above modem may also be realized by a communication chip alone without being integrated into the processor 510.

The memory 520 may include a Random Access Memory (RAM) or a Read-Only Memory. The memory 520 may be configured to store instructions, programs, codes, code sets or instruction sets. The memory 520 may include a program storage area and a data storage area, where the program storage area may store instructions for implementing an operating system, instructions for implementing at least one function (such as a touch function, a sound playing function, an image playing function, etc.), and instructions for implementing various method embodiments described below. The data storage area may further store data (such as phone book, audio and video data, chat record data) created by the electronic device 500 in use.

Referring to FIG. 24, a structural block diagram of a non-transitory computer-readable storage medium provided in an embodiment of the present disclosure is illustrated. Program codes are stored in the computer-readable medium 600, and the program codes may be called by the processor to execute the method described in the above method embodiments.

The computer-readable storage medium 600 may be an electronic memory such as flash memory, Electrically Erasable Programmable Read Only Memory (EEPROM), EPROM, hard disk or ROM. Alternatively, the computer-readable storage medium 600 includes a non-volatile computer-readable storage medium. The computer-readable storage medium 600 has a storage space for program codes 610 for executing any method operations in the method above. These program codes may be read from or written into one or more computer program products. The program codes 610 may be compressed in, for example, an appropriate form.

To sum up, in the file saving method and apparatus, the electronic device and the storage medium provided in the embodiments of the present disclosure, while a first electronic device displays, through screen projection, a display interface of a second electronic device, the first electronic device opens and displays a first file based on a file path displayed in the display interface, then edits the first file to obtain a second file, and sends the second file to the second electronic device. After the second electronic device saves the second file in a public directory, the second file is migrated to an original directory of the first file, thereby replacing the first file with the second file. By sending the file edited by the first electronic device to the second electronic device, and making the edited file first saved in the public directory and then migrated to the original directory, it avoids the problem of lacking read and write access to a file, and enables editing, at the first electronic device cross ends, of a file in any directory of the second electronic device, and saving of the edited file back to the second electronic device. As such, the success rate of saving the file cross ends is improved.

Finally, it is notable that the above embodiments are only configured to illustrate the technical solutions of the present disclosure, rather than limiting them. Although the present disclosure gas been described in detail with reference to the foregoing embodiments, it is understandable for those of ordinary skill in the art that the technical solutions described in the foregoing embodiments may still be modified, or some technical features thereof may be replaced by equivalents; and these modifications or replacements do not drive the essence of the corresponding technical solutions to depart away from the spirit and scope of the technical solutions of the various embodiments of the present disclosure.

What is claimed is:

1. A file saving method, for a first electronic device, the method comprising:
while the first electronic device displays, through screen projection, a display interface of a second electronic device, in response to a file open operation, opening and displaying a first file at the first electronic device, wherein the first file is a file to which a file path displayed in the display interface points;
in response to a file editing operation, editing the first file at the first electronic device, and obtaining the edited first file as a second file; and
sending the second file to the second electronic device, so as to instruct the second electronic device to save the second file to a public directory and then migrate the second file to an original directory of the first file, thereby replacing the first file with the second file.

2. The file saving method of claim 1, wherein sending the second file to the second electronic device comprises:
in response to a file saving operation, sending the second file to the second electronic device.

3. The file saving method of claim 1, wherein opening and displaying the first file at the first electronic device in response to the file open operation, comprises:
in response to a file open operation detected by the first electronic device, opening and displaying the first file at the first electronic device.

4. The file saving method of claim 1, wherein opening and displaying the first file at the first electronic device in response to the file open operation, comprises:
in response to the file open operation, acquiring a file format of the first file; and
in response to the file format meeting a preset file format, opening and displaying the first file at the first electronic device.

5. The file saving method of claim 1, wherein opening and displaying the first file at the first electronic device in response to the file open operation, comprises:
in response to the file open operation, displaying, at the first electronic device, at least one preset file format;
receiving a selection of a preset file format from the displayed at least one preset file format; and
in response to a file format of the first file meeting the selected preset file format, opening and displaying the first file at the first electronic device.

6. The file saving method of claim 1, wherein opening and displaying the first file at the first electronic device in response to the file open operation, comprises:
in response to the file open operation, acquiring a loading time of the first file; and
in response to the loading time being longer than a preset loading time, displaying a loading progress bar at the first electronic device; and in response to completion of loading of the first file, opening and displaying the first file at the first electronic device.

7. The file saving method of claim 6, wherein acquiring the loading time of the first file in response to the file open operation, comprises:
in response to the file open operation, acquiring a file size of the first file; and
acquiring, according to the file size of the first file, the loading time of the first file.

8. The file saving method of claim 6, wherein acquiring the loading time of the first file in response to the file open operation, comprises:
in response to the file open operation, acquiring a file size of the first file and performance of a processor of the first electronic device; and
acquiring the loading time of the first file, according to the file size of the first file and the performance of the processor of the first electronic device.

9. The file saving method of claim 6, wherein acquiring the loading time of the first file in response to the file open operation, comprises:
in response to the file open operation, acquiring a file size of the first file, performance of a processor of the first electronic device and a load rate of the processor of the first electronic device; and
acquiring the loading time of the first file, according to the file size of the first file, the performance of the processor of the first electronic device and the load rate of the processor of the first electronic device.

10. The file saving method of claim 1, wherein opening and displaying the first file at the first electronic device in response to the file open operation, comprises:
in response to the file open operation, sending a file open event to the second electronic device, wherein the file open event carries identification information of the first electronic device;
receiving a file open instruction and the first file which are returned by the second electronic device based on the file open event; and
in response to the file open instruction, opening and displaying the first file at the first electronic device.

11. The file saving method of claim 10, wherein sending the file open event to the second electronic device in response to the file open operation, comprises:
in response to the file open operation, generating the file open event; and
injecting the file open event into a system of the second electronic device, and making the file open event converted into a file open event of the second electronic device.

12. The file saving method of claim 1, wherein after sending the second file to the second electronic device, the method further comprises:
in response to the second file failing to be saved in the second electronic device or the second file being abnormal at the second electronic device, backing up the second file in the first electronic device.

13. The file saving method of claim 12, wherein after backing up the second file in the first electronic device, the method further comprises:
displaying a target control at the first electronic device; and
in response to detecting a touch operation performed on the target control, jumping, in the first electronic device, to a folder in which the second file is backed up.

14. The file saving method of claim 1, wherein editing the first file comprises:
deleting a content from the first file; or
adding a content to the first file; or
modifying a content of the first file.

15. The file saving method of claim 1, wherein sending the second file to the second electronic device, comprises:
after obtaining the second file, immediately sending the second file to the second electronic device; or
after a preset time has elapsed since the second file is obtained, sending the second file to the second electronic device.

16. A file saving method, for a second electronic device, the method comprising:
receiving a second file sent from a first electronic device, wherein the second file is obtained by editing, in response to a file editing operation, a first file by the first electronic device, and the first file is opened and displayed, in response to a file open operation, at the first electronic device while the first electronic device displays, through screen projection, a display interface of the second electronic device, the first file being a file to which a file path displayed in the display interface points;
saving the second file to a public directory; and
migrating the second file saved in the public directory to an original directory of the first file, thereby replacing the first file with the second file.

17. The file saving method of claim 16, wherein before migrating the second file saved in the public directory to the original directory of the first file thereby replacing the first file with the second file, the method further comprises:
acquiring a file size of the second file as a first size, the file size being sent by the first electronic device; and
migrating the second file to the original directory of the first file, thereby replacing the first file with the second file, comprises:
acquiring a file size of the second file saved in the public directory, as a second size; and
in response to the first size being consistent with the second size, migrating the second file saved in the public directory to the original directory of the first file, thereby replacing the first file with the second file.

18. The file saving method of claim 16, wherein the method further comprises:
displaying the display interface of the second electronic device, the display interface at least comprising the file path to the first file; and
in response to a file open operation detected by the second electronic device, opening and displaying the first file at the second electronic device.

19. An electronic device, comprising a memory and a processor, wherein the memory is coupled to the processor, and the memory stores instructions which, when being executed by the processor, cause the processor to:
while the electronic device displays, through screen projection, a display interface of a further electronic device, in response to a file open operation, open and display a first file at the electronic device, wherein the first file is a file to which a file path displayed in the display interface points;
in response to a file editing operation, edit the first file at the electronic device, and obtain the edited first file as a second file; and
send the second file to the further electronic device, so as to instruct the further electronic device to save the second file to a public directory and then migrate the second file to an original directory of the first file, thereby replacing the first file with the second file.

20. The electronic device of claim 19, wherein the instructions, when being executed by the processor, further cause the processor to:
in response to a file saving operation, send the second file to the second electronic device.
